(19) United States
(12) Patent Application Publication
(10) Pub. No.: US 2020/0088305 A1
(43) Pub. Date: Mar. 19, 2020

(54) ELECTROMAGNETIC VALVE

(71) Applicant: NIDEC TOSOK CORPORATION, Kanagawa (JP)

(72) Inventors: Dongming CHEN, Kanagawa (JP); Tomohiko NAKANISHI, Kanagawa (JP)

(73) Assignee: NIDEC TOSOK CORPORATION, Kanagawa (JP)

(21) Appl. No.: 16/563,949

(22) Filed: Sep. 9, 2019

(30) Foreign Application Priority Data
Sep. 13, 2018 (JP) 2018-171365

(51) Int. Cl. F16K 1/54; F16K 31/06; F16K 1/36

(52) U.S. Cl. CPC F16K 1/54; F16K 1/36; F16K 31/0655

(57) ABSTRACT

An electromagnetic valve capable of suppressing excessive flow of a fluid inside an input side pipe portion to an output side pipe portion at the time of valve opening is provided. A valve body of an electromagnetic valve includes a front end portion which is arranged on one side of an axial direction with respect to a barrier and has a diameter larger than the diameter of a through hole, and a valve shaft portion which penetrates through the through hole and extends from the front end portion to another side of the axial direction; a plunger of a solenoid is directly or indirectly connected to the valve shaft portion.

### CROSS-REFERENCE TO RELATED APPLICATION

This application claims the priority benefits of Japan Patent Application No. 2018-171365, filed on Sep. 13, 2018. The entirety of the above-mentioned patent application is hereby incorporated by reference herein and made a part of this specification.

### BACKGROUND

### Technical Field

The disclosure relates to an electromagnetic valve.

### Related Art

An electromagnetic valve is known which includes a solenoid equipped with a movable shaft portion, an input side pipe portion, an output side pipe portion, and a valve body which is directly or indirectly connected to the movable shaft portion, the input side pipe portion and the output side pipe portion including overlapping portions which overlap each other in an axial direction of the movable shaft portion.

For example, an electromagnetic valve according to patent literature 1 (Japanese Laid-Open No. 9-126342) includes a solenoid, an inflow chamber used as an input side pipe portion, an outflow chamber used as an output side pipe portion, and a valve body which is connected to a plunger used as a movable shaft portion of the solenoid. The inflow chamber and the outflow chamber include overlapping portions overlapping in an axial direction of the movable shaft portion of the solenoid. In the overlapping portion, the inflow chamber and the outflow chamber is partitioned off by a barrier. In the barrier, a through hole is arranged. The solenoid penetrates an opening in a wall opposite to the barrier in the inflow chamber in the axial direction and a front end portion of the plunger is positioned inside the inflow chamber. The valve body is connected to a front end of the plunger. If the plunger moves from an inflow chamber side to an outflow chamber side in the axial direction, the valve body connected to the front end of the plunger is pressed against the barrier to block the through hole. By the valve body blocking the through hole, flow of a fluid from the inflow chamber to the outflow chamber through the through hole is blocked. On the other hand, if the plunger moves from the outflow chamber side to the inflow chamber side in the axial direction, the valve body connected to the front end of the plunger is separated from the barrier to open the through hole. By the valve body opening the through hole, the fluid flows from the inflow chamber to the outflow chamber through the through hole.

In the electromagnetic valve disclosed in patent literature 1, at the time of valve opening in which the valve body is separated from the barrier to open the through hole, there is a risk that the high-pressure fluid inside the inflow chamber may excessively flow into the outflow chamber.

### SUMMARY

An exemplary embodiment of the disclosure provides an electromagnetic valve including a solenoid which is equipped with a movable shaft portion, an input side pipe portion, an output side pipe portion, and a valve body which is directly or indirectly connected to the movable shaft portion, wherein the input side pipe portion and the output side pipe portion include overlapping portions which overlap each other in an axial direction of the movable shaft portion, and a barrier between the input side pipe portion and the output side pipe portion in the overlapping portions includes a through hole; wherein the valve body includes a front end portion which is arranged on one side of the axial direction with respect to the barrier and has a diameter larger than a diameter of the through hole, and a valve shaft portion which penetrates through the through hole and extends from the front end portion to another side of the axial direction; and the movable shaft portion is directly or indirectly connected to the valve shaft portion.

### BRIEF DESCRIPTION OF THE DRAWINGS

FIG. 1 is a longitudinal cross-section view of a PCV valve (at the time of valve closing) according to an embodiment.

FIG. 2 is a cross-section view showing an input side pipe portion and an output side pipe portion of the PCV valve.

FIG. 3 is a longitudinal cross-section view showing the PCV valve (at the time of valve opening).

FIG. 4 is a cross-section view showing a valve body which starts movement toward a front side of an axial direction and a barrier in a magnified manner.

FIG. 5 is a cross-section view showing the valve body which moves toward the front side of the axial direction further than in FIG. 4 and the barrier in a magnified manner.

FIG. 6 is a cross-section view showing the valve body and the barrier at the time of valve closing in a magnified manner.

### DESCRIPTION OF THE EMBODIMENTS

According to the exemplary embodiment of the disclosure, the electromagnetic valve which can suppress excessive flow of the fluid inside the input side pipe portion to the output side pipe portion at the time of valve opening is provided.

One embodiment of a Positive Crankcase Ventilation (PCV) valve used as an electromagnetic valve according to the disclosure is described below with reference to the drawings. The PCV valve is arranged in a pipe for returning a blow-by gas which leaks into a crank case from between a piston and a cylinder of an engine of an automobile or the like to an intake side of the engine.

In the drawings below, in order to make each configuration easy to understand, the scale, the number and the like may be different in each structure and the actual structures.

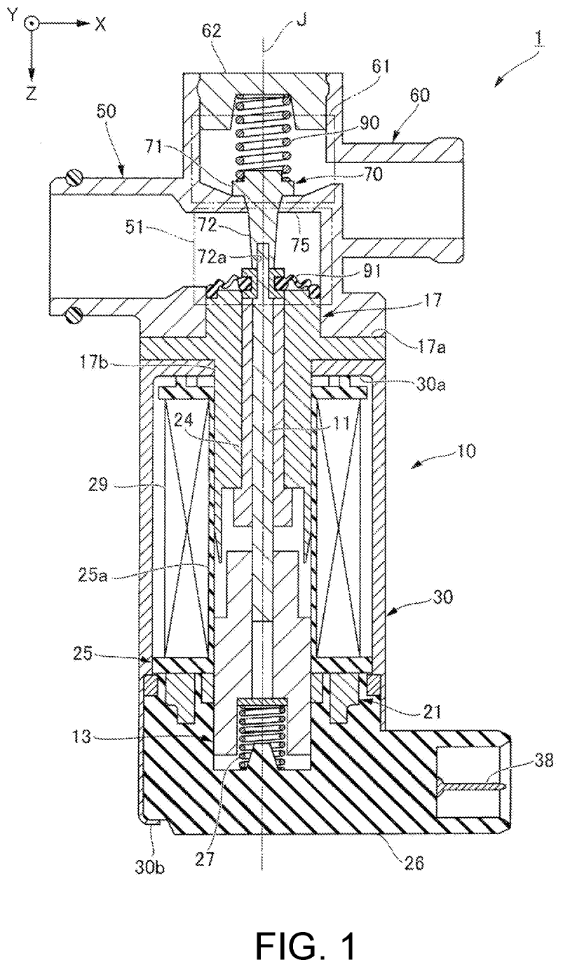

In addition, in the drawings, an XYZ coordinate system is appropriately shown as a three-dimensional orthogonal coordinate system. In the XYZ coordinate system, the Z-axis direction is a direction parallel to the axial direction of a central axis J shown in FIG. 1. The X-axis direction is a direction parallel to a short-side direction of a PCV valve 1 shown in FIG. 1. The Y-axis direction is a direction orthogonal to both the X-axis direction and the Z-axis direction.

In addition, in the following description, a positive side of the Z-axis direction (+Z side) is described as a “rear side”, and a negative side of the Z-axis direction (−Z side) is described as a “front side”. Besides, the rear side and the front side are terms used merely for description and do not limit an actual positional relationship or direction. In addition, unless otherwise noted, the direction (the Z-axis direction) parallel to the central axis J is simply described as an “axial direction”; the radial direction centered on the central axis J is simply described as a “radial direction”; and the peripheral direction centered on the central axis J, that is, the axial periphery of the central axis J (θ direction) is simply described as a “peripheral direction”.

Besides, in the specification, extending in the axial direction includes a case of extending in a direction inclined in a range of smaller than 45° with respect to the axial direction, in addition to a case of exactly extending in the axial direction (the Z-axis direction). In addition, in the specification, extending in the radial direction includes a case of extending in a direction inclined in a range of smaller than 45° with respect to the radial direction, in addition to a case of exactly extending in the axial direction, that is, a direction perpendicular to the radial direction (the Z-axis direction).

The axial direction (the Z-axis direction) in each diagram corresponds to the axial direction of the disclosure. In addition, a front side of the axial direction of each diagram corresponds to one side in the disclosure. In addition, a rear side of the axial direction in each diagram corresponds to another side of the axial direction in the disclosure.

<Overall Configuration>

FIG. 1 is a perspective view of the PCV valve according to an embodiment. As shown in FIG. 1, the PCV valve 1 includes a solenoid 10 for moving a plunger 13 used as a movable shaft in the axial direction, an input side pipe portion 50, an output side pipe portion 60, and a valve body 70. Each structural member is specifically described below.

<Solenoid 10>

The solenoid 10 includes a case 30, a bobbin 25, a core 17, a yoke 21, the plunger 13 and the like.

(Case 30)

The cylindrical case 30 is made of a magnetic metal material such as a material obtained by galvanizing a cold-rolled steel sheet. The case 30 includes a bottom portion 30a disposed on the front side of the axial direction and a caulking portion 30b arranged on an end portion on the rear side of the axial direction. The shape of the cylindrical case 30 is not limited to a precise cylinder-shape. The shape of the cylindrical case 30 may be a shape having a polygonal cross-section. That is, the structure of the case 30 may be a hollow structure in which the cross section is polygonal. Not limited to the case 30, other cylindrical members among the members of the solenoid 10 may also have a hollow structure in which the cross section is polygonal.

The cylindrical body and the bottom portion 30a of the cylindrical case 30 are made of the same magnetic metal material and are molded in the same melding process. The cylindrical body and the bottom portion 30a may also be molded in different molding processes, and the bottom portion 30a may be assembled to the cylindrical body in a subsequent process.

(Bobbin 25)

A coil 29 for generating a magnetic force is wound on the bobbin 25 which is made of a non-magnetic resin material such as nylon that contains carbon fibre. The cylindrical bobbin 25 is disposed inside the cylinder of the case 30.

(Core 17)

The core 17 which is made of a magnetic material such as iron or the like includes a flange portion 17a which expands outward in the radial direction on the front side of the axial direction. The portion of the cylindrical core 17 excluding the flange portion 17a is a body portion 17b. The rear side of the body portion 17b in the axial direction penetrates a through hole arranged in the bottom portion 30a of the case 30 from the outside of the case 30 and is positioned inside the cylinder of the bobbin 25 inside the case 30. Inside the cylinder of the bobbin 25, an outer peripheral surface of the body portion 17b is in close contact with an inner peripheral surface of the bobbin 25.

Outside the case 30, the flange portion 17a of the core 17 is pressed against an outer surface of the bottom portion 30a of the case 30. The front side end portion of the core 17 is positioned inside a through hole arranged in the input side pipe portion 50. The flange portion 17a of the core 17 is clamped between the bottom portion 30a of the case 30 and the input side pipe portion 50.

(Yoke 21)

The cylindrical yoke 21 which is made of a magnetic material such as galvanized iron or the like is positioned on the rear side of the bobbin 25 in the axial direction inside the cylinder of the case 30. The yoke 21 and the bobbin 25 have the same inner diameter and are coaxially disposed.

(Plunger 13)

The plunger 13 which is made of a magnetic material such as iron or the like can move along the axial direction inside cylinders of the yoke 21 and the bobbin 25, and is guided by the yoke 21 and the bobbin 25 to be moved toward the axial direction.

(Shaft Guide 24)

The core 17 includes a round penetration hole along a central axis line. A cylindrical shaft guide 24 is pressed into the cylinder of the core 17. The shaft guide 24 is made of a non-magnetic material such as aluminium bronze or the like.

(Shaft 11)

The shaft 11 is made of a metal material such as a material obtained by nitriding stainless. The shaft 11 penetrates through the cylinder of the shaft guide 24. The rear side end portion in the axial direction of the shaft 11 is pressed into a through hole arranged in the plunger 13. The front side end portion in the axial direction of the shaft 11 is smaller in diameter than the rear side in the axial direction and is pressed into a concave portion 72a of a valve shaft portion 72 of the valve body 70 described later. The shaft 11 can move with the plunger 13 in the axial direction while being guided by the shaft guide 24 to move toward the axial direction.

If a set of the shaft 11 and the plunger 13 moves in the axial direction, the valve body 70 into which the shaft 11 is pressed also moves integrally in the axial direction outside the solenoid 10.

(Coil 29)

The coil 29 is wound around the bobbin 25. The coil 29 is wound in the peripheral direction along an outer peripheral surface of the outside of the radial direction of a cylinder portion 25a of the bobbin 25. Both end portions of the coil 29 are electrically connected to a terminal 38.

(Mold 26)

A mold 26 which is made of a resin material such as polyester or the like is disposed on the rear side end portion in the axial direction of the solenoid 10. The rear side end portion in the axial direction of the case 30 clamps the mold 26 with the yoke 21 in a state that the rear side end portion of the case 30 is swaged as the caulking portion 30b. The mold 26 is fixed to the case 30 by the clamping.

<Pipe Portion>

A pipe portion includes the input side pipe portion 50 and the output side pipe portion 60.

(Input Side Pipe Portion 50)

An external pipe which extends from a crank case of an engine is connected to the input side pipe portion 50 which is made of a metal material such as aluminium alloy or the like. Blow-by gas sent from the crank case of the engine flows into the input side pipe portion 50. The input side pipe portion 50 includes an overlapping portion 51 which overlaps the output side pipe portion 60 in the axial direction.

(Diaphragm 91)

The front side end portion in the axial direction of the shaft 11 of the solenoid 10 penetrates a diaphragm 91 inside the input side pipe portion 50. A peripheral edge of the diaphragm 91 in a direction orthogonal to the axial direction is fixed to an inner wall of the input side pipe portion 50. The diaphragm 91 is made of a material having expandability and heat resistance such as fluorine rubber or the like.

An internal space of the input side pipe portion 50 and an internal space of the solenoid 10 are shielded by the diaphragm 91.

(Output Side Pipe Portion 60)

An external pipe which extends toward an intake manifold of the engine is connected to the output side pipe portion 60 which is made of a metal material such as aluminium alloy or the like. The blow-by gas inside the input side pipe portion 50 flows into the output side pipe portion 60. The output side pipe portion 60 includes an overlapping portion 61 which overlaps the input side pipe portion 50 in the axial direction.

The overlapping portion 61 of the output side pipe portion 60 is positioned on the front side of the overlapping portion 51 of the input side pipe portion 50 in the axial direction. The solenoid 10 is positioned on the rear side of the overlapping portion 51 of the input side pipe portion 50 in the axial direction.

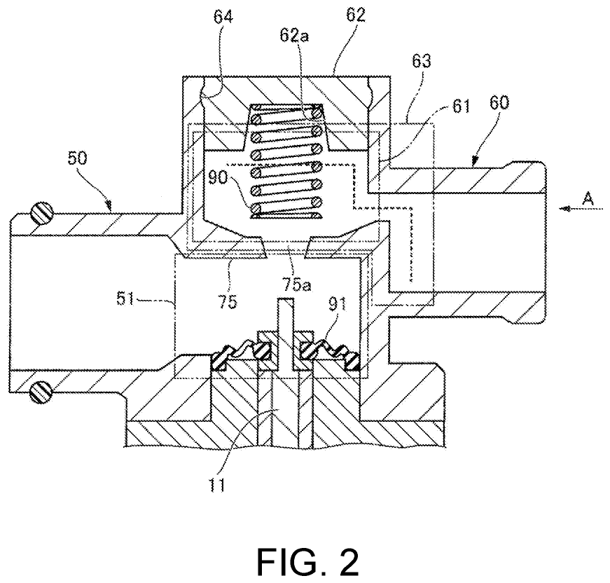

FIG. 2 is cross-section view showing the input side pipe portion 50 and the output side pipe portion 60. In FIG. 2, illustration of the valve body 70 is omitted for convenience. The input side pipe portion 50 and the output side pipe portion 60 are partitioned off by a barrier 75. A through hole 75a is arranged in the barrier 75. The input side pipe portion 50 and the output side pipe portion 60 communicate with each other via the through hole 75a.

An opening 64 is arranged in a front side end portion in the axial direction of the overlapping portion 61 of the output side pipe portion 60. In a peripheral wall of the opening 64, a female thread is cut. A lid member 62 including a male thread in a peripheral wall is screwed into the female thread. The lid member 62 is made of a metal material such as aluminium alloy or the like.

Before the lid member 62 is screwed into the peripheral wall of the opening of the output side pipe portion 60, the valve body 70 and a coil spring 90 shown in FIG. 1 are inserted into the output side pipe portion 60 through the opening. The lid member 62 includes a concave portion 62a for holding a front side in the axial direction of the coil spring 90 used as an elastic body.

The output side pipe portion 60 includes a crank portion 63. In FIG. 2, an arrow A indicates a connection direction of the external pipe to the output side pipe portion 60. FIG. 2 shows a cross-section along the axial direction of the output side pipe portion 60 and the connection direction of the arrow A. A cross-section shape of the crank portion 63 in FIG. 2 is a shape bent into a crank shape as shown by a dotted line in the diagram. A front end side of the crank portion 63 (the input side pipe portion 50 side) overlaps, as the overlapping portion 61, the overlapping portion 51 of the input side pipe portion 50.

The entire region of the crank portion 63 in the external pipe connection direction (the direction of the arrow A) faces the solenoid 10 directly or via the input side pipe portion 50 in the axial direction. That is, the crank portion 63 is disposed inside a region overlapping the solenoid 10 in the axial direction.

Furthermore, instead of arranging the crank portion 63 in the output side pipe portion 60, a similar crank portion may be arranged in the input side pipe portion 50.

Inside the output side pipe portion 60, a taper which descends toward the through hole 75a is arranged in a part of the barrier 75 around the through hole 75a.

In FIG. 1, in a rear side end portion in the axial direction of the coil spring 90, a front end portion 71 of the valve body 70 described below is inserted. The coil spring 90 urges the valve body 70 from the front side of the axial direction to the rear side.

(Valve Body 70)

The valve body 70 includes a front end portion 71 which is arranged on the front side of the axial direction with respect to the barrier 75 and has a diameter larger than the diameter of the through hole 75a, and a valve shaft portion 72 which penetrates through the through hole 75a and extends from the front end portion 71 to another side of the axial direction. A rear side end portion in the axial direction of the valve shaft portion 72 is positioned inside the input side pipe portion 50.

The concave portion 72a is arranged on the rear side end portion in the axial direction of the valve shaft portion 72. The front side end portion in the axial direction of the shaft 11 of the solenoid 10 is pressed into the concave portion 72a. By the pressing, the plunger 13 of the solenoid 10 is indirectly connected, via the shaft 11, to the valve shaft portion 72 which penetrates the through hole 75a of the barrier 75.

In FIG. 1, the front end portion 71 of the valve body 70 which moves to the rear side of the axial direction with the shaft 11 and the plunger 13 is in close contact with a surface around the through hole 75a in the barrier 75 to block the through hole 75a. Hereinafter, the time when the valve body 70 blocks the through hole 75a as shown in FIG. 1 is referred to as the time of valve closing. At the time of valve closing, because the communication between the input side pipe portion 50 and the output side pipe portion 60 via the through hole 75a is blocked, the inflow of the blow-by gas from the input side pipe portion 50 to the output side pipe portion 60 is prevented.

Furthermore, instead of connecting the solenoid 10 to the input side pipe portion 50, the solenoid 10 may be connected to the output side pipe portion 60. Specifically, in a state that the front end portion 71 of the valve body 70 is positioned inside the input side pipe portion 50, the valve shaft portion 72 of the valve body 70 penetrates the through hole 75a of the barrier 75. The end portion of the shaft 11 of the solenoid 10 connected to the output side pipe portion 60 is pressed into the concave portion 72a of the valve shaft portion 72 which penetrates the through hole 75a of the barrier 75.

If a current flows to the coil 29 of the solenoid 10 by energization, a magnetic circuit is generated around the coil 29. Then, the plunger 13 is drawn to the front side from the rear side of the axial direction by a magnetic force. At this time, the plunger 13 presses, against an urging force of the coil spring 90 which is arranged inside the output side pipe portion 60, the shaft 11 and the valve body 70 to move to the front side of the axial direction. On the other hand, if the energization to the coil 29 stops, the magnetic circuit around the coil 29 disappears. Then, the plunger 13 which is drawn to the front side of the axial direction by the magnetic force moves to rear side of the axial direction with the valve body 70 and the shaft 11 due to the urging force of the coil spring 90. At this time, in order to prevent the plunger 13 from colliding with the mold 26 and giving an impact, an internal spring 27 which urges the plunger 13 to the front side of the axial direction is arranged inside the mold 26.

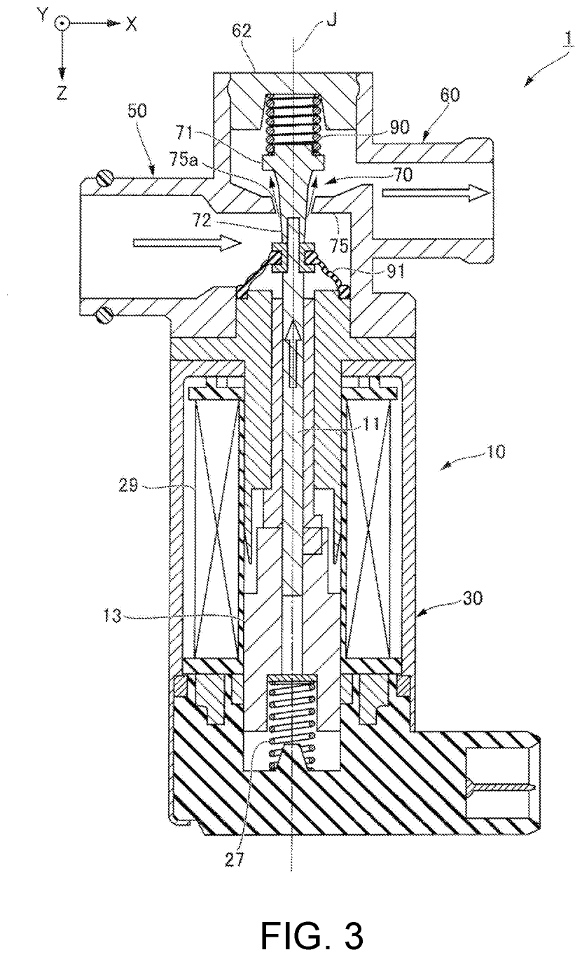

FIG. 3 is a cross-section view showing the PCV valve 1 which is in a state that the plunger 13, the shaft 11, and the valve body 70 are moved to the front side of the axial direction. If the valve body 70 moves to the front side of the axial direction with the plunger 13 and the shaft 11 due to the energization to the coil 29 of the solenoid 10, the front end portion 71 of the valve body 70 is separated from the surface around the through hole 75a in the barrier 75. At this time, a gap is generated between the peripheral wall of the through hole 75a and the valve shaft portion 72. Then, the input side pipe portion 50 and the output side pipe portion 60 are communicated via the through hole 75a. Hereinafter, the time when the valve body 70 moves to the front side of the axial direction to communicate the input side pipe portion 50 and the output side pipe portion 60 as shown in FIG. 3 is referred to as the time of valve opening.

At the time of valve closing, the diaphragm 91 extends in the axial direction to maintain the state in which the internal space of the input side pipe portion 50 and the internal space of the solenoid 10 are shielded.

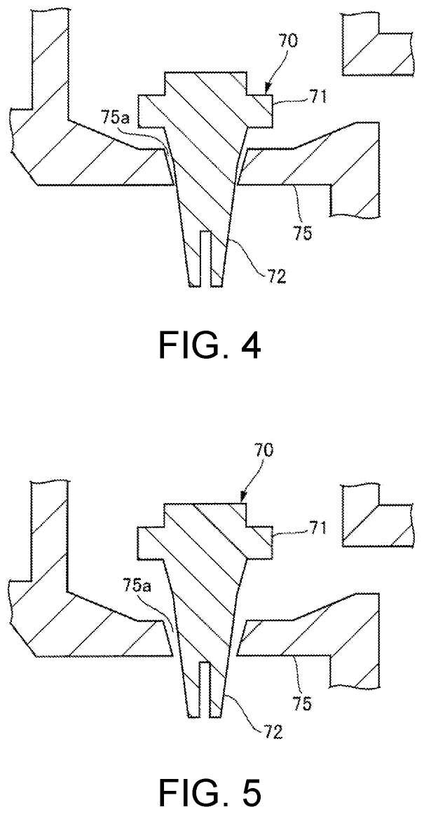

FIG. 4 is a cross-section view showing the valve body 70 which starts the movement toward the front side of the axial direction and the barrier 75 in a magnified manner. FIG. 5 is a cross-section view showing the valve body 70 which moves toward the front side of the axial direction further than in FIG. 4 and the barrier 75 in a magnified manner. The valve shaft portion 72 of the valve body 70 is a tapered shape in which the diameter decreases from the front side toward the rear side along the axial direction. As is known from the comparison between FIG. 4 and FIG. 5, in the process when the valve shaft portion 72 having a tapered shape moves toward the front side of the axial direction for the valve opening, an opening area of the through hole 75a gradually increases.

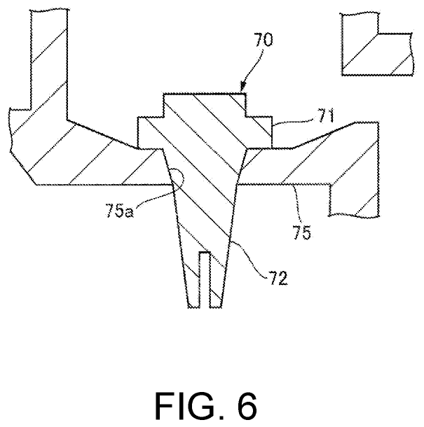

The valve shaft portion 72 includes a portion having a shape and a size the same as the shape and the size of an inner wall of the through hole 75a. As shown in FIG. 6, this portion is in close contact with the entire region of the through hole 75a at the time of valve closing.

<Operation and Effect of PCV Valve 1>

(1) In the PCV valve 1 according to the embodiment, as shown in FIG. 4 and FIG. 5, at the time of valve opening, the valve shaft portion 72 which exists inside the through hole 75a does not open the entire region of the through hole 75a in a direction orthogonal to the axial direction, but only opens a region without the valve shaft portion 72. Therefore, if the through hole 75a has the same size as a conventional configuration, a difference between opening areas at the time of valve closing and at the time of valve opening is further reduced. According to the PCV valve 1 of the embodiment, the difference described above is further reduced, instantaneous inflow of a large amount of the blow-by gas into the output side pipe portion 60 at the time of valve opening can be suppressed, and excessive flow of the blow-by gas to the output side pipe portion 60 can be suppressed.

Furthermore, in a gas electromagnetic valve, there is a risk that if a liquid component contained in the gas freezes after adhering to a barrier surface between an input side pipe portion and an output side pipe portion, a peripheral wall of a through hole of the barrier, or a valve body, an valve opening operation may be obstructed. As in the case of the PCV valve 1 according to the embodiment, if the PCV valve 1 is arranged in a manner that in the front end portion 71 and the valve shaft portion 72 of the valve body 70, the valve shaft portion 72 faces downward in the gravity direction, generation of a valve opening operation failure due to the freezing of a liquid component can be suppressed for reasons described below. That is, the liquid component which adheres to the surface of the barrier 75, the peripheral wall of the through hole 75a, and the valve body 70 falls into the input side pipe portion 50 through the through hole 75a at the time of valve opening. By the falling, the liquid component can be suppressed from becoming the state of adhering to the surface of the barrier 75, the peripheral wall of the through hole 75a, and the valve body 70 for a long time, and thereby generation of a valve closing operation failure can be suppressed.

As in the case of the PCV valve 1 according to the embodiment, when a part around the through hole 75a in the barrier 75 is tapered toward the through hole 75a, the generation of the valve opening operation failure can be suppressed better.

(2) In the PCV valve 1 according to the embodiment, as shown in FIG. 4 and FIG. 5, in the process that the valve body 70 is moved to the front side of the axial direction for valve opening, the opening area of the through hole 75a gradually increases. Therefore, the opening area of the through hole 75a at the time of valve opening is changed corresponding to a movement amount of the plunger 13 toward the front side in the axial direction. Therefore, according to the PCV valve 1 of the embodiment, an inflow amount per unit time from the input side pipe portion 50 to the output side pipe portion 60 can be adjusted by adjusting the movement amount of the plunger 13 toward the front side in the axial direction.

Furthermore, the adjustment of the movement amount of the plunger 13 may be carried out by adjusting the current flowing in the coil 29, or be carried out by adjusting the duty of a pulse voltage applied to the coil 29.

(3) In the PCV valve 1 according to the embodiment, as shown in FIG. 6, in the entire region of the valve shaft portion 72 in the axial direction, the portion having a shape and a size the same as the shape and the size of the inner wall of the through hole 75a is in close contact with the taper-shape peripheral wall of the through hole 75a at the time of valve closing. By the close contact, the PCV valve according to the embodiment can improve the blocking property at the time of valve closing.

(4) In the PCV valve 1 according to the embodiment, the front end portion 71 of the valve body 70 is strongly pressed toward the barrier 75 by the urging force of the coil spring 90 used as the elastic body arranged inside the output side pipe portion 60, and thereby the valve closing property is improved. When larger coil spring 90 is used, the valve closing property is further improved. If a large coil spring is arranged inside the solenoid 10 and the valve body 70 is pulled toward the rear side of the axial direction by this coil spring to obtain a high valve closing property, the solenoid 10 is increased in size. On the other hand, in the PCV valve 1 according to the embodiment, the coil spring 90 which improves the valve closing property is arranged inside the output side pipe portion 60 instead of being arranged inside the solenoid 10. Therefore, according to the PCV valve 1 of the embodiment, the valve closing property can be improved without increasing the size of the solenoid 10.

(5) In the PCV valve according to the embodiment, a configuration in which by arranging the crank portion 63 in the output side pipe portion 60, the external pipe connected to the input side pipe portion 50 and the external pipe connected to the output side are connected to the PCV valve at an approximately coaxial position can be employed. Therefore, according to the PCV valve of the embodiment, layout of the external pipe arranged around the PCV valve 1 can be simplified.

(6) In the PCV valve 1 according to the embodiment, the crank portion 63 of the output side pipe portion 60 is arranged inside the region overlapping the solenoid 10 in the axial direction. Therefore, a horizontal cross-section area of the PCV valve 1 is the same in the case that only the crank portion 63 is removed from the PCV valve 1 and in the case that the crank portion 63 exists in the PCV valve 1. Therefore, according to the PCV valve 1 of the embodiment, the layout of the external pipe arranged around the PCV valve 1 can be simplified without increasing the horizontal cross-section area of the PCV valve 1.

The exemplary embodiments and examples of the disclosure are described above, but the disclosure is not limited to the embodiments above, and can be variously modified and altered within the scope of the gist of the disclosure. For example, the disclosure can also be applied to an electromagnetic valve used for opening and closing a flow path of a liquid instead of being used for opening and closing a flow path of a gas. The embodiment and the modifications thereof are included in the scope and the gist of the disclosure and are included in the disclosure described in the claims and equivalent scopes thereof.

What is claimed is:

1. An electromagnetic valve, comprising:
a solenoid which is equipped with a movable shaft portion, an input side pipe portion, an output side pipe portion, and a valve body which is directly or indirectly connected to the movable shaft portion, wherein the input side pipe portion and the output side pipe portion comprise overlapping portions which overlap each other in an axial direction of the movable shaft portion, and a barrier between the input side pipe portion and the output side pipe portion in the overlapping portions comprises a through hole;
wherein the valve body comprises a front end portion which is arranged on one side of the axial direction with respect to the barrier and has a diameter larger than a diameter of the through hole, and a valve shaft portion which penetrates through the through hole and extends from the front end portion to another side of the axial direction; and
the movable shaft portion is directly or indirectly connected to the valve shaft portion.

2. The electromagnetic valve according to claim 1, wherein
the valve shaft portion is a tapered shape in which the diameter decreases from one side toward another side along the axial direction.

3. The electromagnetic valve according to claim 2, wherein
the valve shaft portion comprises a portion having a shape and a size the same as the shape and the size of an inner wall of the through hole.

4. The electromagnetic valve according to claim 1, wherein
on one of the input side pipe portion and the output side pipe portion which is arranged on one side of the axial direction, an elastic body for urging the front end portion toward another side of the axial direction is arranged.

5. The electromagnetic valve according to claim 1, wherein
one of the input side pipe portion and the output side pipe portion comprises a crank portion;
a cross-section shape of the crank portion along the axial direction and a connect direction of an external pipe with respect to the one of the input side pipe portion and the output side pipe portion is a shape bent into a crank shape; and
a front end side of the crank portion overlaps, as the overlapping portion, another one of the overlapping portions.

6. The electromagnetic valve according to claim 5, wherein the crank portion is arranged in a region which overlaps the solenoid in the axial direction.
